(19) United States
(12) Patent Application Publication
(10) Pub. No.: US 2014/0007221 A1
(43) Pub. Date: Jan. 2, 2014

(54) SECURE IMAGE AUTHENTICATION

(71) Applicant: JASMEET CHHABRA, Hillsboro, OR (US)

(72) Inventor: JASMEET CHHABRA, Hillsboro, OR (US)

(21) Appl. No.: 13/538,652

(22) Filed: Jun. 29, 2012

(51) Int. Cl. G06F 21/00

(52) U.S. Cl. 726/16

(57) ABSTRACT

In one embodiment a controller comprises logic configured to logic configured to define, on a region of a display device, a dialog box, lock the region of the display device on which the dialog box is defined to limit access to an input operation through the dialog box, receive a password from at least one input mechanism in the dialog box, and apply an authentication tag to an image when the password is confirmed. Other embodiments may be described.

### RELATED APPLICATIONS

None.

### BACKGROUND

The subject matter described herein relates generally to the field of electronic devices and more particularly to a system and method to implement secure image authentication using electronic devices.

It may be useful in various applications to authenticate an image collected by an electronic device. By way of example, in some commercial applications it may be useful to permit an electronic device such as a laptop computer, tablet computer, a smartphone or the like to digitally sign a document. Accordingly systems and techniques to provide a secure computing environment for electronic commerce may find utility.

### BRIEF DESCRIPTION OF THE DRAWINGS

The detailed description is described with reference to the accompanying figures.

FIGS. 1-2 are schematic illustrations of exemplary electronic devices which may be adapted to implement secure image authentication t in accordance with some embodiments.

FIG. 3 is a high-level schematic illustration of an exemplary architecture for secure image authentication in accordance with some embodiments.

FIG. 4 is a flowchart illustrating operations in a method to implement secure image authentication in accordance with some embodiments.

FIG. 5 is a schematic illustration of an electronic device which may be adapted to implement secure image authentication in accordance with some embodiments.

### DETAILED DESCRIPTION

Described herein are exemplary systems and methods to implement secure image authentication in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

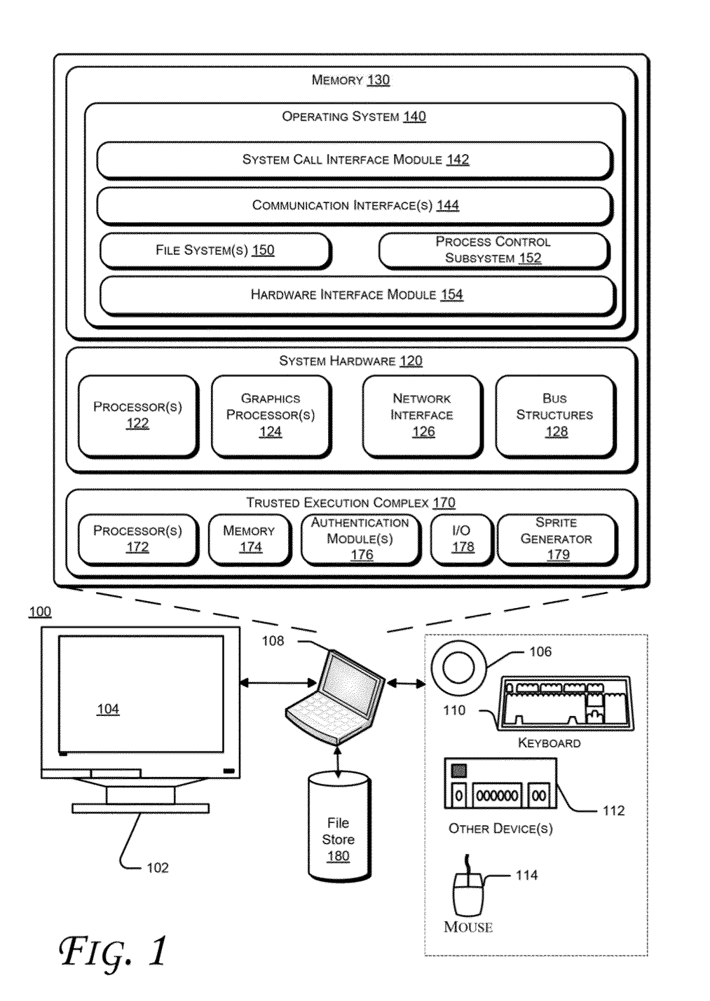

FIG. 1 is a schematic illustration of an exemplary system 100 which may be adapted to implement secure image authentication in accordance with some embodiments. In one embodiment, system 100 includes an electronic device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, a geolocation device, an accelerometer/gyroscope and any other device that allows the system 100 to receive input from a user.

In various embodiments, the electronic device 108 may be embodied as a personal computer, a laptop computer, a personal digital assistant, a mobile telephone, an entertainment device, or another computing device. The electronic device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated into the packaging of processor(s) 122, onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In some embodiments system 100 may comprise a low-power embedded processor, referred to herein as a trusted execution complex 170. The trusted execution complex 170 may be implemented as an independent integrated circuit located on the motherboard of the system 100. In the embodiment depicted in FIG. 1 the trusted execution complex 170 comprises a processor 172, a memory module 174, an authentication module 176, an I/O module 178, and a secure sprite generator 179. In some embodiments the memory module 164 may comprise a persistent flash memory module and the authentication module 174 may be implemented as logic instructions encoded in the persistent memory module, e.g., firmware or software. The I/O module 178 may comprise a serial I/O module or a parallel I/O module. Because the trusted execution complex 170 is physically separate from the main processor(s) 122 and operating system 140, the trusted execution complex 170 may be made secure, i.e., inaccessible to hackers such that it cannot be tampered with.

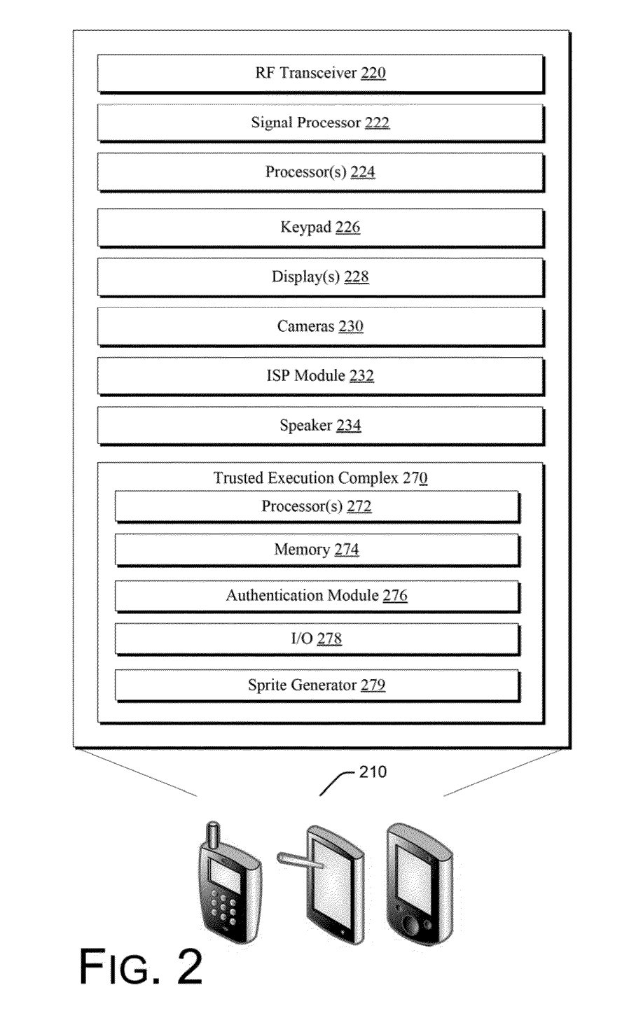

FIG. 2 is a schematic illustration of another embodiment of an electronic device 210 which may be adapted to implement secure image authentication, according to embodiments. In some embodiments electronic device 210 may be embodied as a mobile telephone, a personal digital assistant (PDA), a laptop computer, or the like. Electronic device 210 may include an RF transceiver 220 to transceive RF signals and a signal processing module 222 to process signals received by RF transceiver 220.

RF transceiver 220 may implement a local wireless connection via a protocol such as, e.g., Bluetooth or 802.11x. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11 G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Electronic device 210 may further include one or more processors 224 and a memory module 240. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 224 may be one or more processors in the family of Intel® PXA27x processors available from Intel® Corporation of Santa Clara, Calif. Alternatively, other CPUs may be used, such as Intel's Itanium®, XEON™, ATOM™, and Celeron® processors. Also, one or more processors from other manufactures may be utilized. Moreover, the processors may have a single or multi core design. In some embodiments, memory module 240 includes random access memory (RAM); however, memory module 240 may be implemented using other memory types such as dynamic RAM (DRAM), synchronous DRAM (SDRAM), and the like.

Electronic device 210 may further include one or more input/output interfaces such as, e.g., a keypad 226 and one or more displays 228. In some embodiments electronic device 210 comprises one or more camera modules 230 and an image signal processor 232, and speakers 234.

In some embodiments electronic device 210 may include a trusted execution complex 270 which may be implemented in a manner analogous to that of trusted execution complex 170, described above. In the embodiment depicted in FIG. 2 the trusted execution complex 270 comprises a processor(s) 172, a memory module 274, an authentication module 276, an I/O module 278, and a secure sprite generator 279. In some embodiments the memory module 274 may comprise a persistent flash memory module and the authentication module 276 may be implemented as logic instructions encoded in the persistent memory module, e.g., firmware or software. The I/O module 278 may comprise a serial I/O module or a parallel I/O module. Again, because the trusted execution complex 270 is physically separate from the main processor(s) 224, the trusted execution complex 170 may be made secure, i.e., inaccessible to hackers such that it cannot be tampered with.

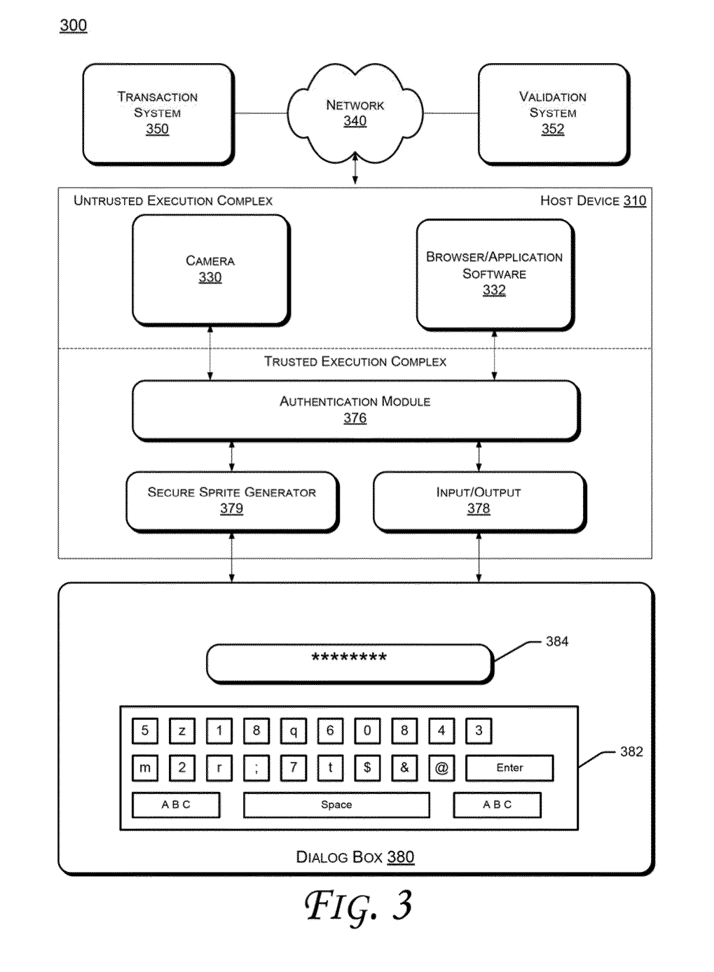

In some embodiments the trusted execution complex may be used for secure image authentication which, in turn, may be used to provide electronic signatures to documents to enable one or more transactions between a host electronic device and a remote computing device, e.g., a online commerce site or the like. FIG. 3 is a high-level schematic illustration of an exemplary architecture for secure image authentication in accordance with some embodiments. Referring to FIG. 3, a host device 310 may be characterized as having an untrusted execution complex and a trusted execution complex. When the host device 310 is embodied as a system 100 the trusted execution complex may be implemented by the trusted execution complex 170, while the untrusted execution complex may be implemented by the main processors(s) 122 and operating system 140 of the system 100. Similarly, when the host device 310 is embodied as an electronic device 210 the trusted execution complex may be implemented by the trusted execution complex 270, while the untrusted execution complex may be implemented by the main processors(s) 224 of the electronic device 210. In some embodiments the trusted execution complex may be implemented in a secure portion of the main processor(s) 122.

As illustrated in FIG. 3, remote entities that originate transactions, may be embodied as electronic commerce websites or the like and may be coupled to the host device via a communication network 340. In use, an owner or operator of host device 310 may access a transaction system 350 using a browser 332 or other application software via the network to initiate an electronic commerce transaction on the system 350. A validation system 352 may be associated with, or communicatively coupled to, transaction system 350. In some embodiments the validation system may request or require a user to provide an electronically authenticated image of a signed document, such as a purchase agreement or the like. The architecture of FIG. 3 permits an host device 310 such as device 108, 210 to implement operations provide an authenticated image of a document in a secure environment, i.e., such that the authentication mechanisms are not available to malware or snoop software which may have infected the untrusted execution complex of the host device 310.

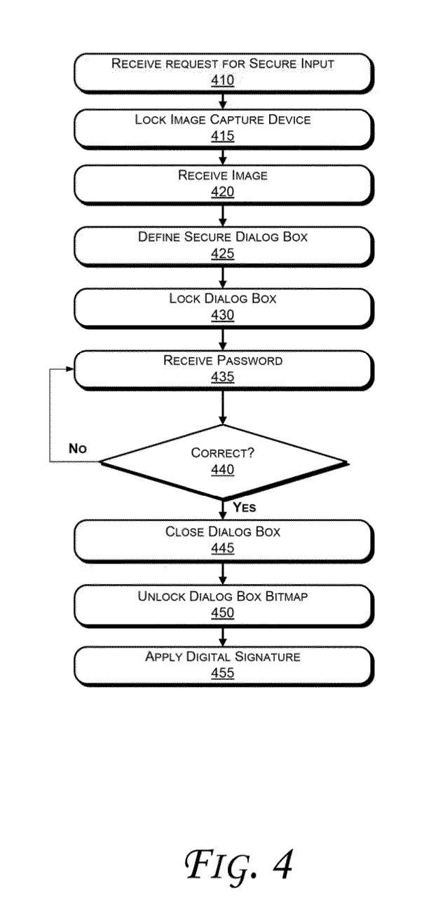

Having described various structures of a system to implement trusted user input, operating aspects of a system will be explained with reference to FIG. 4, which is a flowchart illustrating operations in a method to implement secure image authentication in accordance with some embodiments. In some embodiments the operations depicted in the flowchart of FIG. 4 may be implemented by the authentication module(s) 376 of the trusted execution complex 370 of a host device.

By way of overview, in some embodiments the trusted execution complex implements procedures to receive an image from an image capture device such as a camera in a secure fashion and to apply an authentication process to the image via a secure dialog box on a display of an electronic device. A user of the device may input a password or other code into the secure dialog box and, if the password is confirmed, then an authentication tag may be applied to the image.

Referring to FIG. 4, in operation an application such as, for example, an electronic commerce application, may request a secure input from a user such as, e.g., an electronically signed document. The request may be received via the browser/application software, which forwards the request to the authentication module 376.

At operation 410 the receives the request for secure input. In response to the request, the authentication module 376 and associated functionality operating in the trusted execution complex may lock (operation 415) the image capture device, i.e., the camera, such that the output of the image capture device is not accessible to hardware or software operating in the untrusted execution complex. By way of example, in some embodiments the authentication module 376 may disable communication buses coupled to the image capture device. In other embodiments the authentication module 376 may establish a secure communication connection with the image capture device.

At operation 420 an image is received from the image capture device. In some embodiments the image may be stored in a memory in the trusted execution complex, e.g., memory 174 in the system depicted in FIG. 1 or memory 274 in the system depicted in FIG. 2.

At operation 425 a secure dialog box is generated on a display of the electronic device. By way of example, referring to FIG. 3, in some embodiments the secure sprite generator 379 defines a dialog box 380 on a display of the electronic device. In some embodiments the secure dialog box may include a keypad in which the input keys are randomized, such that the location of a particular character on the keypad cannot be predicted.

At operation 430 the input/output module 378 locks the dialog box 380 such that input/output operations implemented in the dialog box 380 are visible only to the trusted execution complex. In some embodiments the display may be a touchpad display. In such embodiments the outputs of the touchpad sensors in the dialog box 380 are also locked, such that they are accessible only to the trusted execution complex. Once the dialog box is locked input/output operations implemented in the dialog box are not visible to the untrusted execution complex.

At operation 435 a password is received in the dialog box 380. In the embodiment depicted in FIG. 3 the user is requested to enter his or her password in a window 384 of the dialog box 380 using the randomized keyboard 382 generated by the secure sprite generator 379. However, one skilled in the art will recognize that the user may enter other information, e.g., a user identification, password, or the like.

The user can indicate that he or she is finished entering the password, e.g., by clicking the ENTER button on the keyboard. If, at operation 440, the password entered is not confirmed as correct, then control may pass back to operation 435 and the user may be given one or more additional opportunities to enter a password before the login procedure is aborted. By contrast, if at operation 440 the password is correct then the user is finished entering secure input then control passes to operation 445 and the dialog box 280 may be closed and the region of the display on which the dialog box 280 was presented may be unlocked (operation 450).

At operation 455 an electronic signature may be applied to the image. By way of example, in some embodiments the authentication module 176 signs the image using a protected signing key. In addition, in some embodiments the authentication module 176 may generate a hash of the signed document in order to prevent the image from being manipulated after the signature is applied. The signed document may be forwarded to the validation system 352 via the browser 332 in the untrused execution complex.

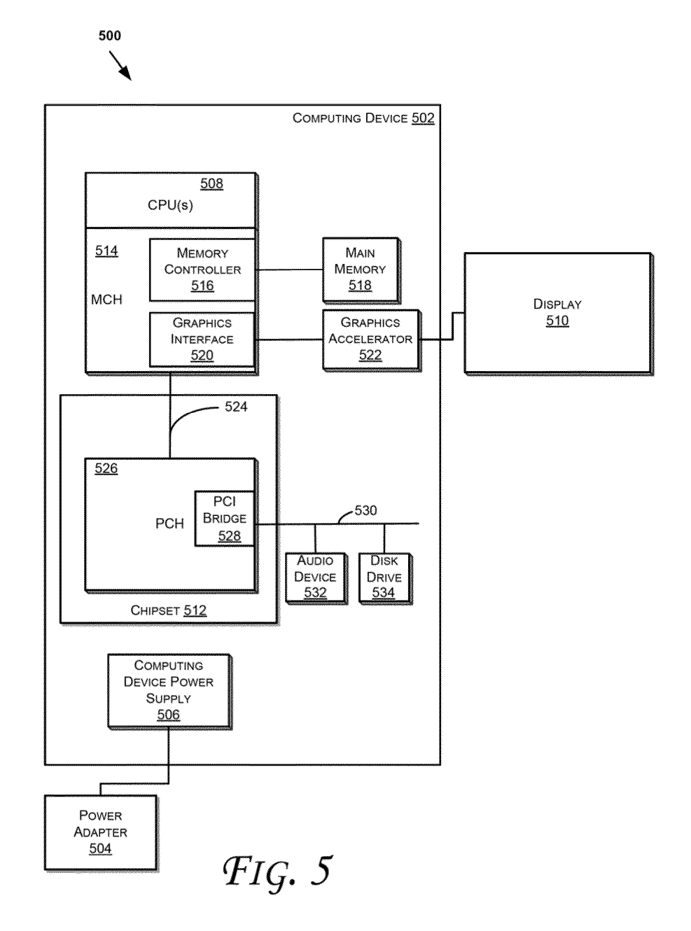

As described above, in some embodiments the electronic device may be embodied as a computer system. FIG. 5 is a schematic illustration of a computer system 500 in accordance with some embodiments. The computer system 500 includes a computing device 502 and a power adapter 504 (e.g., to supply electrical power to the computing device 502). The computing device 502 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 502 (e.g., through a computing device power supply 506) from one or more of the following sources: one or more battery packs, an alternating current (AC) outlet (e.g., through a transformer and/or adaptor such as a power adapter 504), automotive power supplies, airplane power supplies, and the like. In some embodiments, the power adapter 504 may transform the power supply source output (e.g., the AC outlet voltage of about 110VAC to 240VAC) to a direct current (DC) voltage ranging between about 7VDC to 12.6VDC. Accordingly, the power adapter 504 may be an AC/DC adapter.

The computing device 502 may also include one or more central processing unit(s) (CPUs) 508. In some embodiments, the CPU 508 may be one or more processors in the Pentium® family of processors including the Pentium® II processor family, Pentium® III processors, Pentium® IV, CORE2 Duo processors, or Atom processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 512 may be coupled to, or integrated with, CPU 508. The chipset 512 may include a memory control hub (MCH) 514. The MCH 514 may include a memory controller 516 that is coupled to a main system memory 518. The main system memory 518 stores data and sequences of instructions that are executed by the CPU 508, or any other device included in the system 500. In some embodiments, the main system memory 518 includes random access memory (RAM); however, the main system memory 518 may be implemented using other memory types such as dynamic RAM (DRAM), synchronous DRAM (SDRAM), and the like. Additional devices may also be coupled to the bus 510, such as multiple CPUs and/or multiple system memories.

The MCH 514 may also include a graphics interface 520 coupled to a graphics accelerator 522. In some embodiments, the graphics interface 520 is coupled to the graphics accelerator 522 via an accelerated graphics port (AGP). In some embodiments, a display (such as a flat panel display) 540 may be coupled to the graphics interface 520 through, for example, a signal converter that translates a digital representation of an image stored in a storage device such as video memory or system memory into display signals that are interpreted and displayed by the display. The display 540 signals produced by the display device may pass through various control devices before being interpreted by and subsequently displayed on the display.

A hub interface 524 couples the MCH 514 to an platform control hub (PCH) 526. The PCH 526 provides an interface to input/output (I/O) devices coupled to the computer system 500. The PCH 526 may be coupled to a peripheral component interconnect (PCI) bus. Hence, the PCH 526 includes a PCI bridge 528 that provides an interface to a PCI bus 530. The PCI bridge 528 provides a data path between the CPU 508 and peripheral devices. Additionally, other types of I/O interconnect topologies may be utilized such as the PCI Express™ architecture, available through Intel® Corporation of Santa Clara, Calif.

The PCI bus 530 may be coupled to an audio device 532 and one or more disk drive(s) 534. Other devices may be coupled to the PCI bus 530. In addition, the CPU 508 and the MCH 514 may be combined to form a single chip. Furthermore, the graphics accelerator 522 may be included within the MCH 514 in other embodiments.

Additionally, other peripherals coupled to the PCH 526 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 502 may include volatile and/or nonvolatile memory.

Thus, there is described herein an architecture and associated methods to implement trusted user input in electronic devices. In some embodiments the architecture uses hardware capabilities embedded in an electronic device platform to provide assurances to a user that user input is being made in a secure and trusted environment. In the embodiments described herein secure input operations are based on processing that occurs within a trusted environment, separate from the host operating system. The execution environment may be implemented in a trusted execution complex which presents a secure dialog box that includes one or more anti-spoof indicators on a display to provide a user assurance that the input environment is secure. In some embodiments the trusted execution complex may be implemented in a remote device, e.g., a dongle.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A controller, comprising:
logic configured to:
define, on a region of a display device, a dialog box;
lock the region of the display device on which the dialog box is defined to limit access to an input operation through the dialog box;
receive a password from at least one input mechanism in the dialog box; and
apply an authentication tag to an image when the password is confirmed.

2. The controller of claim 1, wherein the logic is further configured to establish a secure link between the image capture device and the controller.

3. The controller of claim 1, wherein the logic is further configured to:
receive an indication that an input operation in the dialog box is complete, and in response the input, to:
close the dialog box; and
unlock the region of the display device on which the dialog box was defined.

4. The controller of claim 1, wherein the logic is further configured to reposition the positions of touch keys presented in the dialog box.

5. The controller of claim 1, wherein the logic is further configured to:
compare the password received via the dialog box with at least one other password; and
confirm the password when there is a match based on the comparison.

6. The controller of claim 5, wherein the logic is further configured to:
apply a digital signature key to the image when there is a match based on the comparison.

7. The controller of claim 6, wherein the logic is further configured to generate a hash of the image and the digital key.

8. An electronic device, comprising:
a display device;
a processor; and
a controller comprising:
logic configured to:
define, on a region of a display device coupled to the controller, a dialog box;
lock the region of the display device on which the dialog box is defined to limit access to an input operation through the dialog box;
receive a password from at least one input mechanism in the dialog box; and
apply an authentication tag to an image when the password is confirmed.

9. The electronic device of claim 8, wherein the logic is further configured to establish a secure link between the image capture device and the controller.

10. The electronic device of claim 8, wherein the logic is further configured to:
receive an indication that an input operation in the dialog box is complete, and in response the input, to:
close the dialog box; and
unlock the region of the display device on which the dialog box was defined.

11. The electronic device of claim 8, wherein the logic is further configured to reposition the positions of touch keys presented in the dialog box.

12. The electronic device of claim 8, wherein the logic is further configured to:
compare the password received via the dialog box with at least one other password; and
confirming the password when there is a match based on the comparison.

13. The electronic device of claim 12, wherein the logic is further configured to:
apply a digital signature key to the image when there is a match based on the comparison.

14. The electronic device of claim 13, wherein the logic is further configured to generate a hash of the image and the digital key.

15. A computer program product comprising logic instructions stored on a tangible computer readable medium which, when executed by a controller, configure the secure controller to:
define, on a region of a display device, a dialog box;
lock the region of the display device on which the dialog box is to limit access to an input operation through the dialog box;
receive a password from at least one input mechanism in the dialog box; and
apply an authentication tag to an image when the password is confirmed.

16. The computer program product of claim 15, further comprising logic instructions stored on a tangible computer readable medium which, when executed by a controller, configure the controller to establish a secure link between the image capture device and the controller.

17. The computer program product of claim 15, further comprising logic instructions stored on a tangible computer readable medium which, when executed by a controller, configure the controller to:
receive an indication that an input operation in the dialog box is complete, and in response the input, to:
close the dialog box; and
unlock the region of the display device on which the dialog box was defined.

18. The computer program product of claim 15, further comprising logic instructions stored on a tangible computer readable medium which, when executed by a controller, configure the controller to reposition the positions of touch keys presented in the dialog box.

19. The computer program product of claim 15, further comprising logic instructions stored on a tangible computer readable medium which, when executed by a controller, configure the controller to:
compare the password received via the dialog box with at least one other password; and
confirming the password when there is a match based on the comparison.

20. The computer program product of claim 19, further comprising logic instructions stored on a tangible computer readable medium which, when executed by a controller, configure the controller to:
apply a digital signature key to the image when there is a match based on the comparison.

21. The computer program product of claim 20, further comprising logic instructions stored on a tangible computer readable medium which, when executed by a controller, configure the controller to generate a hash of the image and the digital key.

22. A method, comprising:
defining, on a region of a display device coupled to the controller, a dialog box;
locking the region of the display device on which the dialog box is defined to limit access to an input operation through the dialog box;
receiving a password from at least one input mechanism in the dialog box; and
applying an authentication tag to an image when the password is confirmed.

23. The method of claim 22, further comprising establishing a secure link between the image capture device and the controller.

24. The method of claim 22, further comprising receiving an indication that an input operation in the dialog box is complete, and in response the input:
closing the dialog box; and
unlocking the region of the display device on which the dialog box was defined.

25. The method of claim 22, further comprising repositioning the positions of touch keys presented in the dialog box.

26. The method of claim 22, further comprising:
comparing the password received via the dialog box with at least one other password; and
confirming the password when there is a match based on the comparison.

27. The method of claim 26, further comprising:
applying a digital signature key to the image when there is a match based on the comparison.

28. The method of claim 27, further comprising generating a hash of the image and the digital key.
